(19) United States
(12) Patent Application Publication
(10) Pub. No.: US 2021/0379641 A1
(43) Pub. Date: Dec. 9, 2021

(54) STAMPING TOOL

(71) Applicant: Ehrt Maschinenbau GmbH, Rheinbreitbach (DE)

(72) Inventor: Andreas Winters, Rheinbreitbach (DE)

(21) Appl. No.: 17/287,485

(22) PCT Filed: Oct. 22, 2019
(86) PCT No.: PCT/EP2019/078646

§ 371 Date: Apr. 21, 2021

(30) Foreign Application Priority Data
Oct. 22, 2018 (DE) 10 2018 126 203.5
Apr. 17, 2019 (DE) 10 2019 110 171.9

(51) Int. Cl. B21D 28/34; B21D 37/12

(52) U.S. Cl. CPC B21D 28/34; B21D 37/12

(57) ABSTRACT

The invention concerns a stamping tool with a tool upper body, an intermediate plate, at least one stamping unit, in particular several stamping units, a tool lower body to guide the stamping unit and at least two guide pillars to guide the tool upper body relative to the intermediate plate, which are solidly connected to the intermediate plate, wherein the guide pillar is arranged eccentrically and the stamping unit has a stamping punch and a stamping die separate from the stamping punch, the stamping die being operatively connected with the tool upper body.

The invention concerns a stamping tool. Furthermore, the invention concerns a processing machine with the stamping tool.

A large number of differently designed stamping tools are known in prior art. The stamping tools differ from one another in the number of stamping units and/or in their construction.

The task of the present invention is to provide an improved stamping tool.

The task is resolved by a stamping tool with a tool upper body, an intermediate plate, at least one stamping unit, in particular several stamping units, a tool lower body to guide the stamping unit and at least two guide pillars to guide the tool upper body relative to the intermediate plate which are connected solidly to the intermediate plate, wherein the guide pillars are arranged eccentrically and the stamping unit has a stamping punch and a stamping die, operatively connected with the tool upper body and separate from the stamping punch.

The advantage of the stamping tool according to the invention is that, due to the several eccentrically arranged guide pillars in a central area of the stamping tool, a lot of installation space is available. This is of particular advantage in stamping tools which have several stamping units.

The eccentric arrangement of the guide pillars means that no guide pillar is present running coaxially to a central axis of the stamping tool. The separate design of the stamping punch and of the stamping die means that both parts are not designed as one piece.

In one particular design, the tool upper body can have a seating for holding the stamping punch and a part of the stamping die. The seating can be designed as an opening so that a stamping punch can be operated directly from outside, such as by an actuator. This offers the advantage that, in the case of stamping tools having several stamping units, the stamping units can be operated separately from one another. It is conceivable, therefore, that a single stamping unit or several stamping units can be operated simultaneously by the actuator. The actuator can have a hydraulic cylinder.

In addition, the tool upper body can have at least one bushing to accommodate the guide pin. It is therefore easily possible to achieve the low resistant motion of the tool upper body relative to the intermediate plate. During the stamping operation and/or during the movement of the tool upper body relative to the intermediate plate, the guide pillars remain fixed in place relative to the intermediate plate and are not moved, therefore.

During an idle state of the stamping tool, the tool upper body can be arranged with a gap separating it from the intermediate plate. In particular, during an idle state of the stamping tool, the tool upper body and the intermediate plate do not come into contact. This means that an intermediate space exists between the tool upper body and the intermediate plate. The stamping tool can have means of establishing the gap which ensures that the tool upper body is arranged with a prescribed gap from the intermediate plate.

In a particular design, the intermediate plate can be solidly attached to the tool lower body. In particular, the intermediate plate can be releasably joined firmly to the tool lower body. This can be realised, for example, by a screw connection. The tool lower body can extend from the intermediate plate in a direction pointing away from the tool upper body. Thus, in a stamping operation, the stamping die can leave the tool lower body and protrude from it.

When the stamping tool is idle, the tool upper body, the intermediate plate and the tool lower body can be designed and arranged such that the intermediate plate is arranged along the central axis of the stamping tool between the tool upper body and the tool lower body.

The design of the section normal to the axis of the tool upper body can be polygonal, in particular rectangular. The design of the section normal to the axis of the intermediate plate can be polygonal, in particular rectangular. The design of the section normal to the axis of the tool lower body can be round.

Each of the guide pillars can be arranged in a corner region of the tool upper body and/or the intermediate plate. The forces arising during the stamping operation can be absorbed by the guide pillars. A stamping tool is particularly advantageous in which four guide pillars are provided. In this arrangement, each of the guide pillars is arranged in a corner region of the rectangular tool upper body and/or the rectangular intermediate plate. The guide pillars also have the advantage that they prevent the turning of the tool upper body around a central axis of the stamping tool relative to the intermediate plate. The guide pillars can be aligned such that their longitudinal axis runs parallel to the central axis of the stamping tool.

In the case of one particular design, the stamping unit can be arranged eccentrically. This means that a longitudinal axis of the stamping units is arranged so that it is not coaxial to the central axis of the stamping tool. This type of design offers the advantage that several stamping units can be provided. By providing several stamping units, each of the stamping units can be arranged eccentrically. The stamping units may be identical in construction. As a result, a stamping tool can be provided by means of which a workpiece can be stamped simultaneously at different points in one stamping operation.

The stamping tool can be designed in such a fashion that a stamping direction is coaxial to a guide direction. In particular, a stamping direction can be axially offset and/or can be parallel to the central axis of the stamping tool.

At its end away from the intermediate plate, the tool lower body can have a stripper device. The stripper device can have at least one stripper. The function of the stripper is to guide the stamping unit of the stamping tool. Furthermore, the stripper ensures that, after a stamping operation, the workpiece does not move together with the stamping unit when the stamping unit is retracted. In other words, the stripper ensures that, after the stamping operation, a separation develops between the stamping unit and the workpiece. Furthermore, by means of the stripper any contamination such as material workpiece remnants present on the stamping unit, in particular on the stamping die should be prevented from entering the stamping tool.

The tool lower body can have another seating which is arranged partly in the stamping die. While the stamping tool is in its idle state, the stamping die can be arranged partly in the intermediate space between the tool upper body, in particular a lower side of the tool upper body, and the intermediate plate, in particular an upper side of the intermediate plate.

Particularly on its side facing the stamping punch, the stamping die can have a T-shaped stamping head. The stamping die and the workpiece body can be connected together positively. The positive connection can be realised wherein the T-shaped stamping head and the wall defines the accommodation of the tool upper body. Thus, in a stamping operation, due to the positive connection existing with the tool upper body, the stamping head can ensure that the tool upper body moves in the direction towards the workpiece.

In doing so, the stamping punch can be supported, in particular directly, on the stamping die. In this manner, an operative connection can be realised simply between the stamping punch and the stamping die. Thus, the stamping punch can be designed as a plunger.

The stamping unit can have a spring which is supported at one end on the stamping punch and at the other end on the tool upper body. During a stamping operation, the spring is tensioned. In this arrangement, in each case, another spring can be assigned to a stamping unit of the stamping tool. In a stamping operation, wherein, for example, just one stamping unit stamps the workpiece, the function of the spring is to force the stamping punch of the stamping unit, which is not stamping the workpiece, towards the workpiece. This is a simple way of preventing the end of the stamping punch away from the stamping die from projecting out of the tool upper body.

A processing machine is particularly advantageous for processing a workpiece with a tool holder in which a stamping tool is arranged.

The stamping tool is not screwed to the tool holder. During a stamping operation, the stamping tool moves towards the workpiece. In doing so, the tool holder acts as a guide for the stamping tool.

The subject matter of the invention is shown diagrammatically In the Figures, wherein the same elements, or those elements acting in the same manner, are provided with the same reference symbols. They show, in:

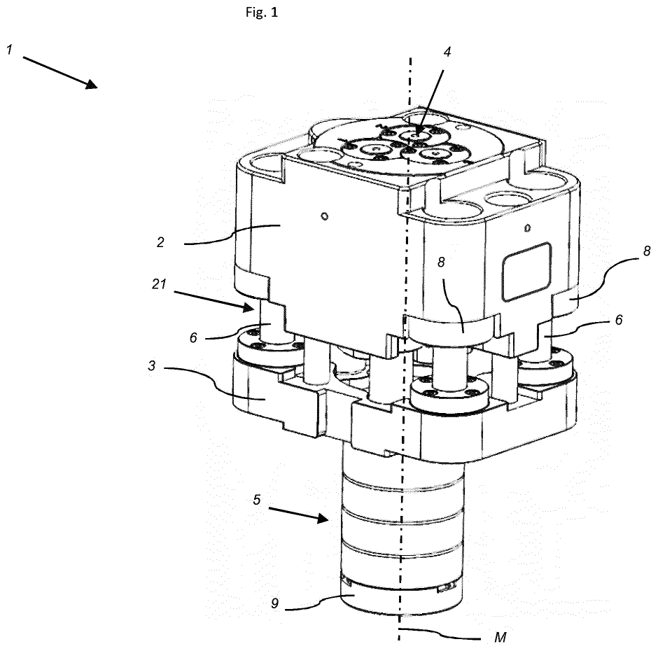

FIG. 1 a perspective illustration of the stamping tool according to the invention,

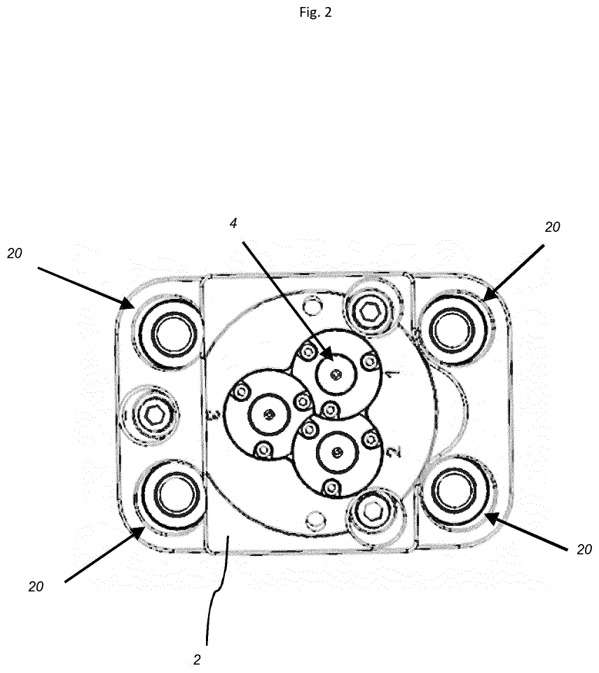

FIG. 2 a top view over the stamping tool according to the invention,

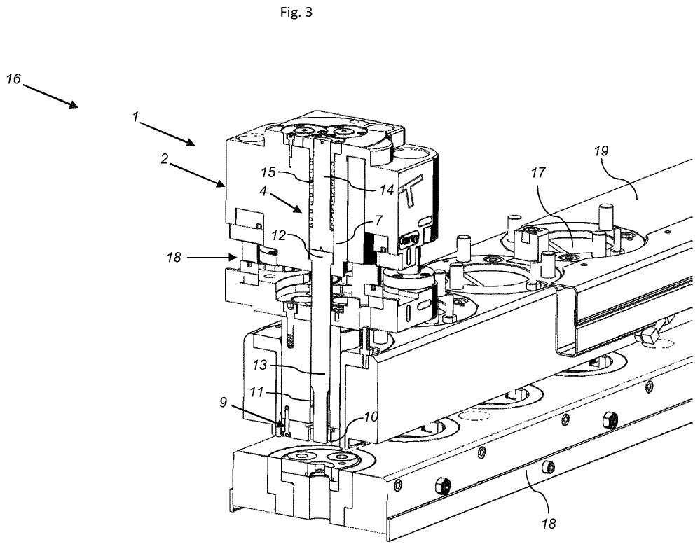

FIG. 3 a sectional view of a part of a processing machine with the stamping tool according to the invention.

A stamping tool 1 shown in FIG. 1 has a tool upper body 2, an intermediate plate 3, three stamping units 4 and a tool lower body 5. Furthermore, the stamping tool 1 has four guide pillars 6 to guide the tool upper body 2 relative to the intermediate plate 3. The guide pillars 6 are solidly attached to the intermediate plate 3 and are arranged eccentrically. This means that the longitudinal axes of the guide pillars are not coaxial to a central axis M of the stamping tool 1.

The stamping unit 4 has a stamping punch 14 shown in FIG. 3 in the form of a plunger and a stamping die 13 separate from the stamping punch, the stamping die being operatively connected to the tool upper body 3. In this arrangement, each of the three stamping units 4 of the stamping tool 1 is built identically.

The tool lower body 5 is connected non-rotatably to the intermediate plate 3 and extends from a lower side of the intermediate plate 3 away from the tool upper body 2. On its end away from the intermediate plate 3, the tool lower body 5 has a stripper device 9.

In the state illustrated in FIG. 1, where no stamping operation is taking place, the intermediate plate 3 and the tool upper body 2 are arranged in such a way that an intermediate space 21 is formed between the intermediate plate 3 and the tool upper body 2. In this respect, the intermediate plate 3 and the tool upper body 2 are arranged so that they are separated from each other along the direction of the central axis M. In particular, the intermediate plate 3 and the tool upper body 2 are arranged so that they are separated from one another in such a way that they do not come into contact when the stamping tool 1 is in its idle state.

Each of the four guide pillars 6 is solidly attached by one end with the intermediate plate 3. The solid connection is achieved by means of a screw connection. In addition, each of the guide pillars 6 is arranged in a bushing 8. The bushing 8 is a component part of the tool upper body 2.

The stamping units 4 are also arranged eccentrically. Correspondingly, no longitudinal axis of the stamping units 4 is coaxial with the central axis M of the stamping tool 1.

FIG. 2 shows a top view over the stamping tool 1 shown in FIG. 1. As can be seen in FIG. 2, the tool upper body 2 has an essentially rectangular shape. Here, each of the guide pillars 6 is arranged in a corner region 20 of the tool upper body 2. Since, as can be seen from FIG. 1, the intermediate plate 3 is also essentially rectangular in shape, each of the guide pillars is also arranged in a corner region of the intermediate plate 3.

FIG. 3 shows a sectional view of a part of a processing machine 16 with the stamping tool 1. The processing machine 16 has a tool magazine 19 having several tool holders 17. A stamping tool 1 can be inserted into each of the tool holders 17. In this arrangement, the stamping tool 1 is not screwed to the tool holder 17. Furthermore, the processing machine 16 has a machine table 18 which carries a workpiece to be stamped, though not shown here.

The stamping punch 14 is arranged in a receptacle 7 of the tool upper body 2. Thus, the stamping punch 14 is located with one end on the stamping die 13. A spring 15 is also arranged in the receptacle 7. The spring 15 is supported at one end on the stamping punch 14 and at another end on a component of the tool upper body 2 in each case.

The stamping die 13 is guided by a stripper 10. The stripper 10 is arranged in a seating in the stripper device 9. The stamping die 13 has a stamping head 12, which is arranged on the end of the stamping die 13 away from the stripper 10. The stamping head 12 is T-shape in design and is arranged in the seating 7. In particular, the stamping head 12 is positively connected to the tool upper body 2.

The stamping die 13 extends partly through a seating 11 in the tool lower body 7, the intermediate space 19 and the seating 7 of the tool upper body 2.

In a stamping operation, the stamping tool 1 is lowered towards the machine table 18 wherein the tool holder 17 guides the movement of the stamping tool 1. In doing so, an actuator of the processing machine 16, not shown in the Figures, actuates a stamping unit 4 or several stamping units 4 of the stamping tool 1 to stamp the workpiece (not shown).

After actuation of the stamping unit 4 by the actuator, the stamping punch 14 forces the stamping head 12 towards the workpiece (not shown). The stamping die 13 exits the stripper 10 to stamp the workpiece. Due to the positive connection between the stamping die 13 and the tool upper body 2, a force directed towards the workpiece acts on the tool upper body 2. This results in the tool body 2 also moving towards the workpiece. In doing so, the spring 15 is tensioned in each stamping unit 4.

### REFERENCE LIST

1 Stamping tool

2 Tool upper body

3 Intermediate plate

4 Stamping unit

5 Tool lower body

6 Guide pillar

7 Seating

8 Bushing

9 Stripper device

10 Stripper

11 Other opening

12 Stamping head

13 Stamping die

14 Stamping punch

15 Spring

16 Processing machine

17 Tool holder

18 Machine table

13 Tool magazine

20 Corner region of the tool upper body

21 Intermediate space

M Central axis of the stamping tool

1. Stamping tool with a tool upper body, an intermediate plate, at least one stamping unit, in particular several stamping units, a tool lower body to guide the stamping unit and at least two guide pillars to guide the tool upper body relative to the intermediate plate, which is solidly connected to the intermediate plate wherein the guide pillars are arranged eccentrically and the stamping unit has a stamping punch and a stamping die separate from the stamping punch, the stamping die being operatively connected to the tool upper body.

2. Stamping tool according to claim 1, characterised in that
a. the tool upper body has a seating to accommodate the stamping punch and a part of the stamping die and/or that
b. the tool upper body has at least one bushing to accommodate the guide pillar.

3. Stamping tool according to claim 1, characterised in that
a. in an idle state of the stamping tool, the tool upper body is arranged at a distance from the intermediate plate and/or that
b. in an idle state of the stamping tool, the tool upper body and the intermediate plate are not in contact.

4. Stamping tool according to claim 1, characterised in that
a. the intermediate plate is solidly attached to the tool lower body and/or that
b. the tool lower body extends from the intermediate plate in a direction pointing away from the tool upper body.

5. Stamping tool according to claim 1, characterised in that each of the guide pillars is arranged in a corner region of the tool upper body and/or of the intermediate plate.

6. Stamping tool according to claim 1, characterised in that
a. the stamping unit is arranged eccentrically and/or that
b. the stamping tool has several stamping units, and the stamping units are arranged eccentrically.

7. Stamping tool according to claim 1, characterised in that
a. a stamping direction is coaxial to a guide direction and/or that
b. a stamping direction is offset and/or is parallel to a central axis of the stamping tool.

8. Stamping tool according to claim 1, characterised in that
a. the tool upper body is designed as a polygon, in particular rectangular, in a section normal to the axis and/or that
b. the intermediate plate is designed as a polygon, in particular rectangular, in a section normal to the axis and/or that
c. the tool lower body is designed to be round in a section normal to the axis.

9. Stamping tool according to claim 1, characterised in that
a. the tool lower body has a stripper device on its end away from the intermediate plate or that
b. the tool lower body has a stripper device on its end away from the intermediate plate wherein the stripper device has at least one stripper to guide the stamping die.

10. Stamping tool according to claim 1, characterised in that
a. the tool lower body has another seating, in which the stamping die is partly arranged and/or that
b. in an idle state of the stamping tool, the stamping die is partly arranged in an intermediate space.

11. Stamping tool according to claim 1, characterised in that
a. the stamping die has a T-shaped stamping head and/or that
b. the stamping die and the tool upper body are connected positively to each other.

12. Stamping tool according to claim 1, characterised in that
a. the stamping punch rests, in particular directly, on the stamping die and/or that
b. the stamping punch is designed as a plunger.

13. Stamping tool according to claim 1, characterised in that the stamping unit has a spring which is supported by one end on the stamping punch and, at another end, on the tool upper body.

14. Processing machine to process a workpiece with a tool holder in which a stamping tool according to any one of claims 1 to 13 is arranged.
